(19) United States
(12) Patent Application Publication
(10) Pub. No.: US 2006/0034342 A1
(43) Pub. Date: Feb. 16, 2006

(54) Electrode cooling device

(76) Inventor: Uwe Kark, Hamburg (DE)

Correspondence Address: ALIX YALE & RISTAS LLP, 750 MAIN STREET, SUITE 1400, HARTFORD, CT, 06103, US

(21) Appl. No.: 10/523,664

(22) PCT Filed: Aug. 8, 2003
(86) PCT No.: PCT/EP03/08823

§ 371 Date: Feb. 4, 2005

(30) Foreign Application Priority Data
Aug. 8, 2002 (DE) 102 36 442.7

(51) Int. Cl. H05B 7/10

(52) U.S. Cl. 373/94

(57) ABSTRACT

Electrode holder with an electrode cooling device on its underside, said electrode cooling device being electrically insulated from the electrode holder in order to avoid damage by arcing. To improve the protection of the electrode holder, the cooling device essentially covers the underside of said holder. To improve the spray cooling, the nozzles are equipped with a compressed air supply.

It is known to cool the graphite electrodes of arc furnaces by spraying cooling water against the surface of the electrodes. For this purpose, arranged underneath the electrode holder attached to the electrode carrying arm is a spray ring, which is formed by a tube to which cooling water is admitted and directs spray nozzles toward the surface of the electrodes. The cooling has the effect of reducing the electrode consumption and also protecting the clamping devices for the electrode from excessive heat exposure. The known arrangement has the disadvantage that electric arcs which may damage both the cooling device and the electrode holder can occur. This applies in particular if the electrode ruptures; there is then the risk of the electrode holder settling on the stump of the electrode connected to the bath. The same may happen if there are remains of scrap on the furnace.

According to the invention, these disadvantages are reduced or eliminated by the electrode cooling device being electrically insulated from the electrode holder. As a result, not only the cooling device but also the electrode holder are protected. This protection of the electrode holder can be improved in comparison with a conventional arrangement of the cooling device by the electrode cooling device essentially covering the underside of the electrode holder. It is formed with a large surface area and is given an outer contour which is similar to or the same as that of the electrode holder (seen from below). It can be fastened to fixed parts of the electrode holder. It may project freely under the movable parts of the electrode holder or—more expediently—be supported on them in such a way that the clamping movements of these parts do not impair the support.

For the connection or support of the electrode cooling device on the electrode holder, releasable fastening devices must be provided. In order that effects of the furnace do not render them unusable, they should be arranged above cooled parts of the electrode cooling device. They are expediently accessible from the side.

Furthermore, the invention seeks to improve the cooling action of the spray nozzles. For this purpose, a compressed air supply is provided on the spray nozzles, providing better distribution and possibly also alignment of the cooling water with the parts to be cooled. The cooling is made more effective as a result and the consumption of cooling medium is lowered. Thanks to the better distribution, adequate cooling can also be maintained if one or other of the spray nozzles should happen to fail. If need be, this feature is worthy of protection independently of the claims to which reference is made.

The failure of nozzles caused by splashes can be prevented according to the invention by a shield which covers the direct spraying direction from the bath or arc to the nozzles being provided underneath the nozzles.

The invention is explained in more detail below with reference to the drawing, which illustrates an advantageous exemplary embodiment and in which:

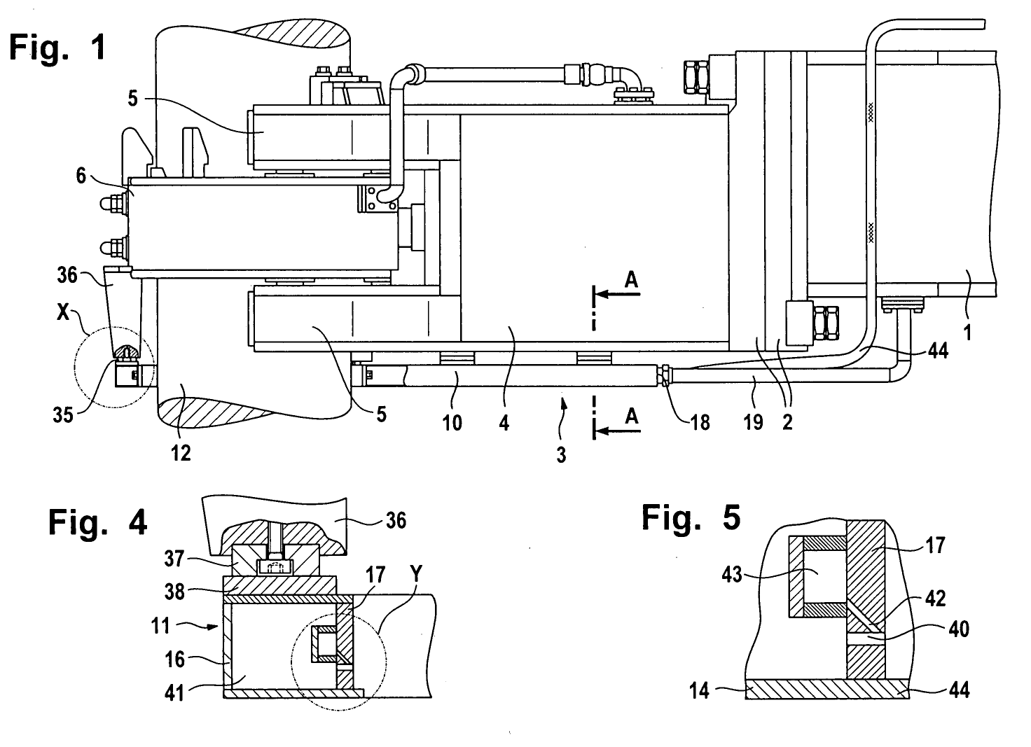

FIG. 1 shows the side view of an electrode holder with a cooling device;

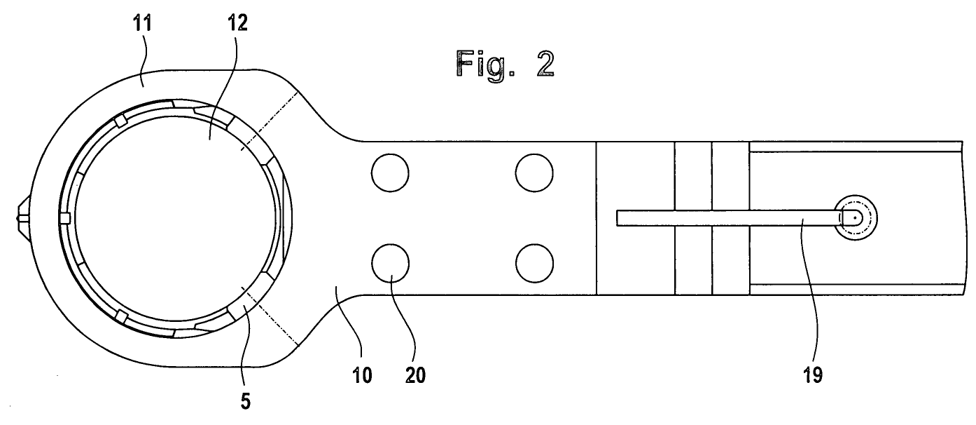

FIG. 2 shows the underside of the electrode holder and cooling device;

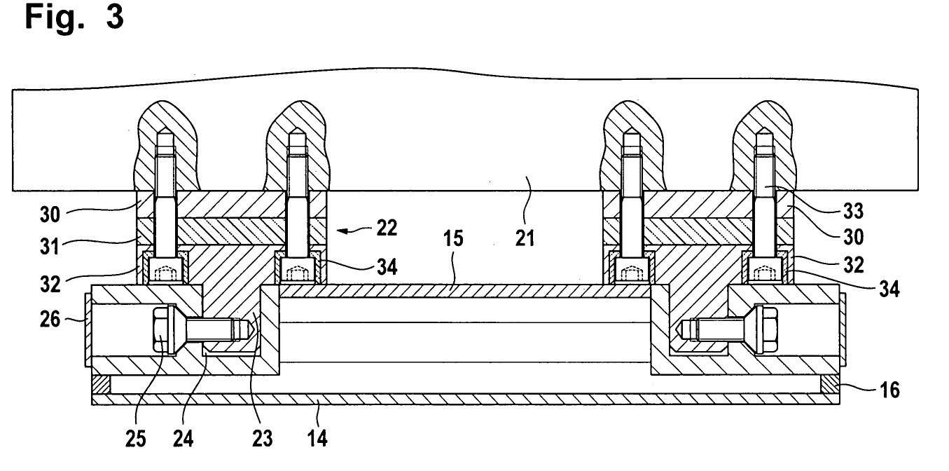

FIG. 3 shows a partial section along section line A-A of FIG. 1;

FIG. 4 shows the detail “X” indicated in FIG. 1; and

FIG. 5 shows the detail “Y” indicated in FIG. 4.

Fastened to the front end 1 of an electrode arm by means of flanges 2 is the electrode holder 3, which comprises a rear, shaft-like part 4, fixed clamping jaws 5 connected to said part and a movable clamping jaw 6. This arrangement is of a conventional type and is provided with suitable drive and coolant supply lines.

Arranged underneath the electrode holder 3 is the cooling device 10 formed according to the invention, which has the outer shape of a horizontal plate, the outline of which is essentially the same as that of the electrode holder 3, as FIG. 2 shows in particular. In its front region, it forms an annular part 11, which encloses the electrode 12.

The cooling device is a flat, hollow box, which is formed by a lower wall 14, an upper wall 15 and a surrounding outer wall 16. In the region of the annular part 11 there is also an inner wall 17. At the rear end 18, the box is likewise closed by a suitable wall and connected by means of a line 19 to a cooling water source.

The cooling device 10 is connected to the fixed part 4 of the electrode holder by four fastening devices, which are indicated generally in FIG. 2 by the reference numeral 20. Corresponding fastening devices may also be provided for the fixed clamping jaws 5. Their construction is represented more precisely in FIG. 3. Attached to the lower plate 21 of the electrode holder are studs 22, each of which reaches with its portion 23 into a depression 24 in the cooling device 10 and is secured there by means of a bolt 25, to be fitted from the side. The head of the bolt 25 sits in a depression, which is protected by means of a plate 26 which is releasably fastened in a suitable way.

The stud 22 is electrically insulating. For example, it may consist completely of electrically insulating material. In the example represented, it comprises a first plate 30, welded to the lower plate 22, an insulating plate 31 and a stud plate 32 screwed thereto, the screws 33 being electrically isolated from the stud plate 32 by insulating inserts 34. This has the effect that the cooling device 10 is electrically isolated from the electrode holder. It goes without saying that the cooling water supply line 19 is also correspondingly insulated.

The annular part 11 of the cooling device may protrude freely from the rear part of the cooling device, held by means of the fastening devices just explained. It is better if it is additionally supported on the movable parts of the holder 6. Provided for this is a device 35, which is represented in more detail in FIG. 4. Protruding downward from the clamping jaw 6 is a support 36, which ends in an insulating plate 37. Fastened on the upper side of the part 11 of the cooling device is a sliding plate 38, which bears against the insulating plate 37. The electrode terminal 6 can move freely over this supporting device within the predetermined range without losing the supporting effect.

An additional insulation of the contact jaws can have the effect that dust does not cause bridging.

The cooling device acts as a heat protecting plate for the electrode holder and in this way can increase its service life significantly. It can easily be retrofitted on existing holders. Since the assembly screws 25 are protected and it is ensured in this way that they remain operational, rapid and speedy assembly and disassembly can be expected.

To make it possible if desired for the cooling device to be provided for a fitted electrode, it may be provided that the annular part 11 of the cooling device is formed in a divided manner.

The annular part 11 of the cooling device is formed such that it is hollow in a manner similar to its rear part. Arranged in the wall 17 are nozzle bores 40, through which the pressurized cooling water located in the interior space 41 of the cooling device is sprayed out against the surface of the electrode 12. Opening out obliquely into the bore 40 is a bore 42, which extends from a compressed air line 43, which is welded onto the inner periphery of the wall 17 alongside the row of spray bores 40. It is connected in a way not represented to a compressed air supply line 44 (FIG. 1), which is connected to the cooling device 10 in an electrically insulating manner.

The compressed air supply to the spray nozzles 14 assists the distribution of the cooling water and the formation of the spray jet. The surface of the electrode is wetted better and the cooling action is correspondingly increased.

FIG. 5 reveals that the lower wall 14 protrudes inwardly at the inner periphery of the annular part 11 of the cooling device more than the wall 17. As a result, the mouth of the spray bore 40 is shielded better in the downward direction and protected from splashes which could lead to blocking.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. An electrode assembly comprising an electrode holder for an electrode and an electrode cooling device arranged underneath said electrode holder and comprising cooling-water spray nozzles having bores and being directed at the electrode, characterized in that the nozzles are equipped with a compressed air supply.

22. The electrode assembly as claimed in claim 21, characterized in that the compressed air supply opens out into the bores of the spray nozzles.

23. The electrode assembly as claimed in claim 21, characterized in that a row of spray nozzles is arranged on or in a wall of the cooling device and connected to the wall along this row is a compressed air line, from which connecting bores lead to the bores of the spray nozzles.

24. The electrode assembly as claimed in claim 21, characterized in that the spray nozzles have openings and a shield which covers the direct spraying direction from a bath or an arc to the openings is provided underneath the openings of the spray nozzles.

25. The electrode assembly as claimed in claim 24, characterized in that, underneath the spray nozzles, the cooling device comprises a wall which runs transversely in relation to the direction of the electrode and an edge of which protrudes further toward the electrode than the nozzles, to form the shield.

26. The electrode assembly as claimed in claim 21, characterized in that the electrode cooling device is electrically insulated from the electrode holder.

27. The electrode assembly as claimed in claim 21, characterized in that the electrode cooling device essentially covers the underside of the electrode holder.

28. The electrode assembly as claimed in claim 21, characterized in that the electrode cooling device is fastened to fixed parts of the electrode holder and is supported on a movable part of the electrode holder.

29. The electrode assembly as claimed in claim 21, characterized in that releasable fastening and supporting elements for the electrode cooling device are arranged above cooled parts of the same.

30. The electrode assembly as claimed in claim 29, characterized in that the releasable fastening and supporting elements are accessible from the side.

31. The electrode assembly as claimed in claim 22, characterized in that a row of spray nozzles is arranged on or in a wall of the cooling device and connected to the wall along this row is a compressed air line, from which connecting bores lead to the bores of the spray nozzles.

32. The electrode assembly as claimed in claim 22, characterized in that the spray nozzles have openings and a shield which covers the direct spraying direction from a bath or an arc to the openings is provided underneath the openings of the spray nozzles.

33. The electrode holder as claimed in claim 23, characterized in that the spray nozzles have openings and a shield which covers the direct spraying direction from a bath or an arc to the openings is provided underneath the openings of the spray nozzles.

34. The electrode assembly as claimed in claim 31, characterized in that the spray nozzles have openings and a shield which covers the direct spraying direction from a bath or an arc to the openings is provided underneath the openings of the spray nozzles.

35. The electrode assembly as claimed in claim 22, characterized in that the electrode cooling device is electrically insulated from the electrode holder.

36. The electrode assembly as claimed in claim 23, characterized in that the electrode cooling device is electrically insulated from the electrode holder.

37. The electrode assembly as claimed in claim 24, characterized in that the electrode cooling device is electrically insulated from the electrode holder.

38. The electrode assembly as claimed in claim 25, characterized in that the electrode cooling device is electrically insulated from the electrode holder.

39. The electrode assembly as claimed in claim 22, characterized in that the electrode cooling device essentially covers the underside of the electrode holder.

40. The electrode assembly as claimed in claim 23, characterized in that the electrode cooling device essentially covers the underside of the electrode holder.
